(19) United States
(12) Patent Application Publication
(10) Pub. No.: US 2026/0267371 A1
(43) Pub. Date: Sep. 10, 2026

(54) Clock synchronization monitoring system

(71) Applicant: Mellanox Technologies, Ltd., Yokneam (IL)

(72) Inventors: Natan Manevich, Nesher (IL); Dotan David Levi, Kiryat Motzkin (IL); Wojciech Wasko, Mlynek (PL); Maciej Machnikowski, Reda (PL)

(21) Appl. No.: 19/658,575

(22) Filed: Apr. 26, 2026

Related U.S. Application Data
(62) Division of application No. 18/349,976, filed on Jul. 11, 2023, now Pat. No. 12,669,843.

(51) Int. Cl. G06F 1/12

(52) U.S. Cl. CPC G06F 1/12

(57) ABSTRACT

In one embodiment, a clock parameter monitoring system includes an interface to receive indications of values of a clock parameter from processing devices, and a processor to compare the received indications of the values of the clock parameter, and detect an anomaly in a hardware clock of one of the processing devices responsively to comparing the received indications of the values of the clock parameter.

### RELATED APPLICATION INFORMATION

The present application is a Divisional Patent Application of US Patent Application S/N 18/349,976 of Manevich, et al., filed 11 Jul. 2023.

### FIELD OF THE INVENTION

The present invention relates to computer systems, and in particular, but not exclusively, to time synchronization.

### BACKGROUND

A hardware clock in a network device may be disciplined to a remote clock such as a clock over the network or to a Global navigation satellite system (GNSS). Many clock synchronization methods are available to provide accurate clock synchronization. One such method is based on the Precision Time Protocol (PTP), for example.

A hardware clock in a host device connected to the network device may synchronize to the hardware clock in the network device. One method is for the host device to poll the network device several times for the time maintained by the network device and take an average of the received times. This method may introduce errors of at least a few hundred nanoseconds, which in many applications is too large.

Another method for synchronizing the clock of a host device to the clock of a network device is Precision Time Measurement (PTM), a supported feature in the PCI-SIG® PCI Express 3.0 specification, which defines a new protocol of timing measurement and synchronization messages for time-sensitive media and server applications. Examples include industrial automation, instrumentation, geological sciences, telecom synchronization, and synchronized audio/video systems, among others. PTM enables systems that require high precision timing, the ability to monitor and track the time of transactions with sub-microsecond timing accuracy while accelerating server application performance.

### SUMMARY

There is provided in accordance with an embodiment of the present disclosure, a system, including a follower processing device including a follower hardware clock to maintain a follower clock value, and follower clock synchronization circuitry to synchronize the follower hardware clock to a remote hardware clock, and provide an indication about the follower hardware clock to a reference processing device, and a reference processing device including a reference hardware clock to maintain a reference clock value, and reference clock synchronization circuitry to monitor a quality of synchronization of the follower hardware clock.

Further in accordance with an embodiment of the present disclosure the reference clock synchronization circuitry is configured to monitor the quality of the synchronization of the follower hardware clock responsively to the provided indication about the follower hardware clock.

Still further in accordance with an embodiment of the present disclosure the follower hardware clock is not synchronized to the reference hardware clock.

Additionally in accordance with an embodiment of the present disclosure the indication is a value of a clock parameter of the follower hardware clock, the clock parameter including one or more of the following a clock time of the follower hardware clock, a clock frequency of the follower hardware clock, a stability of the follower hardware clock, a filtered noise metric of the follower hardware clock, and /or an unfiltered noise metric of the follower hardware clock.

Moreover, in accordance with an embodiment of the present disclosure the reference clock synchronization circuitry is configured to discipline the reference hardware clock responsively to a remote clock.

Further in accordance with an embodiment of the present disclosure the follower clock synchronization circuitry is configured to synchronize the follower hardware clock to the reference hardware clock using a given clock synchronization method, and the reference clock synchronization circuitry is configured to monitor the quality of the synchronization of the follower hardware clock independently of the given clock synchronization method.

Still further in accordance with an embodiment of the present disclosure, the system includes data communication bus connecting the reference processing device and the follower processing device.

Additionally in accordance with an embodiment of the present disclosure the reference clock synchronization circuitry and the follower clock synchronization circuitry are configured to exchange clock synchronization messages in order to synchronize the follower hardware clock to the reference hardware clock.

Moreover in accordance with an embodiment of the present disclosure, the system includes a connector, wherein the reference processing device includes a pulse input unit, the follower clock synchronization circuitry includes a pulse output unit, the connector is configured to connect the pulse output unit to the pulse input unit, and the pulse output unit is configured to output periodic pulses indicative of the follower clock value to the pulse input unit via the connector, responsively to the follower clock value being equal to given clock values.

Further in accordance with an embodiment of the present disclosure the reference clock synchronization circuitry is configured to receive one of the periodic pulses from the pulse input unit and sample the reference clock value responsively to receiving the one periodic pulse.

Still further, in accordance with an embodiment of the present disclosure the reference clock synchronization circuitry is configured to send the sampled reference clock value to the follower processing device or to a management node.

Additionally in accordance with an embodiment of the present disclosure the follower processing device or the management node includes a processor to determine if a clock drift of the follower clock value from the reference clock value exceeds a limit responsively to the sampled reference clock value, and perform an action responsively to the clock drift exceeding the limit.

Moreover, in accordance with an embodiment of the present disclosure the reference clock synchronization circuitry is configured to determine if a clock drift of the follower clock value from the reference clock value exceeds a limit responsively to the sampled reference clock value, and send a request to the follower processing device or to a management node to perform an action responsively to the clock drift exceeding the limit.

Further in accordance with an embodiment of the present disclosure the reference clock synchronization circuitry is configured to determine if a clock drift of the follower clock value from the reference clock value exceeds a limit responsively to the sampled reference clock value, and perform an action responsively to the clock drift exceeding the limit.

Still further in accordance with an embodiment of the present disclosure the reference processing device includes packet processing circuitry, which is configured to block a flow of packets from the follower processing device responsively to the clock drift exceeding the limit.

Additionally in accordance with an embodiment of the present disclosure the follower clock synchronization circuitry is configured to provide time-of-day (TOD) messages to the reference clock synchronization circuitry, which is configured to determine if a clock drift of the follower clock value from the reference clock value exceeds a limit responsively to the sampled reference clock value and at least one of the time-of-day messages.

Moreover, in accordance with an embodiment of the present disclosure the follower clock synchronization circuitry is configured to provide the time-of-day messages at a frequency greater than two times a frequency of the periodic pulses.

Further in accordance with an embodiment of the present disclosure the follower clock synchronization circuitry is configured to provide the time-of-day messages periodically.

Still further in accordance with an embodiment of the present disclosure the reference clock synchronization circuitry is configured to receive the indication from the follower processing device and sample the reference clock value responsively to receiving the indication.

Additionally in accordance with an embodiment of the present disclosure the reference clock synchronization circuitry is configured to send the sampled reference clock value to the follower processing device or to a management node.

Moreover, in accordance with an embodiment of the present disclosure the follower processing device or the management node includes a processor to determine if a clock drift of the follower clock value from the reference clock value exceeds a limit responsively to the sampled reference clock value, and perform an action responsively to the clock drift exceeding the limit.

Further in accordance with an embodiment of the present disclosure the reference clock synchronization circuitry is configured to determine if a clock drift of the follower clock value from the reference clock value exceeds a limit responsively to the sampled reference clock value, and send a request to the follower processing device or to a management node to perform an action responsively to the clock drift exceeding the limit.

Still further in accordance with an embodiment of the present disclosure the reference clock synchronization circuitry is configured to determine if a clock drift of the follower clock value from the reference clock value exceeds a limit responsively to the sampled reference clock value, and perform an action responsively to the clock drift exceeding the limit.

Additionally in accordance with an embodiment of the present disclosure the follower processing device includes a central processing unit (CPU) or a graphics processing unit (GPU).

Moreover, in accordance with an embodiment of the present disclosure the follower processing device and the reference processing device are included in a network switch including packet processing circuitry and a central processing unit (CPU).

Further in accordance with an embodiment of the present disclosure the reference processing device includes any one or more of the following a network device to be connected to a network and connect to the remote clock over the network, a network interface controller to be connected to the network and connect to the remote clock over the network, a network switch to connect to the remote clock over the network, and a timecard to be connected to a satellite time source, which is the remote clock.

There is also provided in accordance with another embodiment of the present disclosure, a system, including a peripheral device including a reference hardware clock to maintain a reference clock value, and reference clock synchronization circuitry, and multiple host devices, each host device including a follower hardware clock to maintain a follower clock value, and follower clock synchronization circuitry to synchronize the follower hardware clock of a respective one of the host devices to a remote hardware clock, and provide an indication about the follower clock value of the respective host device to the reference processing device, wherein the reference clock synchronization circuitry is configured to monitor a quality of synchronization of the follower hardware clock of each host device responsively to the provided indication about the follower clock value of the respective host device.

Still further in accordance with an embodiment of the present disclosure, the system includes connectors, wherein the peripheral device includes a pulse input unit, the follower clock synchronization circuitry of each host device includes a pulse output unit, a respective one of the connectors is configured to connect the pulse output unit of each host device to the pulse input unit, and the pulse output unit of each host device is configured to output periodic pulses indicative of the follower clock value of the respective host device to the pulse input unit via the respective connector, responsively to the follower clock value of the respective host device being equal to given clock values.

Additionally in accordance with an embodiment of the present disclosure the pulse output unit of each host device is configured to time the output of the periodic pulses in a round-robin manner with respect to other ones of the host devices.

Moreover, in accordance with an embodiment of the present disclosure, the system includes a pulse input-output switch to receive the periodic pulses output by the pulse output unit of each host device and output the received periodic pulses to the pulse input unit.

Further in accordance with an embodiment of the present disclosure the pulse-input-output switch is configured to select from the periodic pulses output by the hosts devices in a round-robin manner for output to the pulse input unit.

Still further in accordance with an embodiment of the present disclosure the pulse-input-output switch is disposed on a mother board of the host devices, or disposed on a mother board of the peripheral device, or a standalone device disposed between the host devices and the peripheral device.

Additionally in accordance with an embodiment of the present disclosure, the system includes connectors, wherein the peripheral device includes multiple pulse input units, the follower clock synchronization circuitry of each host device includes a pulse output unit, a respective one of the connectors is configured to connect the pulse output unit of each host device to a respective one of the pulse input units, and the pulse output unit of each host device is configured to output periodic pulses indicative of the follower clock value of the respective host device to the respective pulse input unit via the respective connector, responsively to the follower clock value of the respective host device being equal to given clock values.

There is also provided in accordance with still another embodiment of the present disclosure, a method, including maintaining a reference clock value, maintaining a follower clock value, synchronizing a follower hardware clock to a remote hardware clock, providing an indication about the follower hardware clock to a reference processing device, and monitoring a quality of synchronization of the follower hardware clock.

There is also provided in accordance with still another embodiment of the present disclosure, a clock parameter monitoring system, including an interface to receive indications of values of a clock parameter from processing devices, a processor to compare the received indications of the values of the clock parameter, and detect an anomaly in a hardware clock of one of the processing devices responsively to comparing the received indications of the values of the clock parameter.

There is also provided in accordance with still another embodiment of the present disclosure, a clock parameter monitoring method, including receiving indications of values of a clock parameter from processing devices, comparing the received indications of the values of the clock parameter, and detecting an anomaly in a hardware clock of one of the processing devices responsively to comparing the received indications of the values of the clock parameter.

### BRIEF DESCRIPTION OF THE DRAWINGS

The present invention will be understood from the following detailed description, taken in conjunction with the drawings in which:

FIG. 1 is a block diagram view of a clock synchronization and monitoring system constructed and operative in accordance with an embodiment of the present invention;

FIG. 2 is a flowchart including steps in a method of clock synchronization performed by a reference processing device of the system of FIG. 1;

FIG. 3 is a flowchart including steps in a method of clock synchronization by a follower processing device of the system of FIG. 1;

FIG. 4 is a flowchart including steps in a method of providing time indications by a follower processing device of the system of FIG. 1;

FIG. 5 is a flowchart including steps in a method of monitoring a quality of the synchronization of the follower by a reference processing device of the system of FIG. 1;

FIG. 6 is a flowchart including steps in a method of acting on the method of quality monitoring of FIG. 5;

FIG. 7 is a block diagram view of a first multi-host clock synchronization and monitoring system constructed and operative in accordance with an embodiment of the present invention;

FIG. 8 is a block diagram view of a second multi-host clock synchronization and monitoring system constructed and operative in accordance with an embodiment of the present invention;

FIG. 9 is a block diagram view of a third multi-host clock synchronization and monitoring system constructed and operative in accordance with an embodiment of the present invention;

FIG. 10 is a block diagram view of a fourth multi-host clock synchronization and monitoring system constructed and operative in accordance with an embodiment of the present invention;

FIG. 11 is a block diagram view of a clock parameter monitoring system constructed and operative in accordance with an embodiment of the present invention; and

FIG. 12 is a flowchart including steps in a method of operation of the system of FIG. 11.

### DESCRIPTION OF EXAMPLE EMBODIMENTS

### OVERVIEW

Certain systems require high precision timing. In such systems, it is important for the hardware clock of the processing device to be accurately synchronized. For example, when a host hardware clock is synchronized to the hardware clock of a connected network device, synchronization software running on the host device may malfunction leading to a clock drift (from the network device clock) greater than an acceptable limit. Without additional information, the host device and/or network device may assume the worst-case scenario, and assume that the clock drift of the host hardware clock is too large, and act on the assumption that the host clock is not synchronized enough to perform certain time critical tasks (e.g., database updates).

Embodiments of the present invention address some of the above drawbacks by a reference processing device that monitors clock synchronization quality of the follower processing device. The reference device may or may not provide a reference clock to the follower processing device. Clock synchronization quality may provide a measure (e.g., measured in nanoseconds) of clock drift (and other synchronization quality metrics) between the time maintained by a hardware clock of the reference processing device and the time maintained by a hardware clock of the follower processing device. Monitoring the synchronization of the follower hardware clock from the reference processing device checks that the follower hardware clock is synchronized accurately enough, and remains synchronized, and if not, an appropriate action may be taken by the reference processing device, or by the follower processing device, or by a management node. The term “monitor a quality of the synchronization”, in all grammatical forms, as used in the specification and claims, may include checking that the clock(s) running on the follower processing device(s) are within given limits defined quantitively by one or more clock metrics such as clock drift, clock stability, a filtered and/or unfiltered noise metric. The monitoring may include receiving an indication about a clock parameter of the follower processing device (or indications of clock parameters from multiple follower processing devices), and based on the indication(s), may also include computing the quality of synchronization, comparing the received indications from different follower devices to identify an anomaly, and/or initiating an action for the reference processing device(s) or sending data to another device (e.g., management node or the follower processing device(s) e.g., to initiate an action for the reference processing device(s) or to perform anomaly detection by the other device. It should be noted that the clock(s) of the follower processing device(s) may be synchronized to the clock of the reference processing device using a given clock synchronization method. Therefore, even if the clock synchronization method fails (e.g., due to a software crash) the reference processing device may still be able to monitor the quality of the synchronization of the follower processing device(s) using the monitoring. In some embodiments, the clock(s) of the follower processing device(s) may be synchronized to another device, and not to the clock of the reference processing device. Whether or not the clock(s) of the follower processing device(s) are synchronized to the clock of the reference processing device using a given clock synchronization method, the term “monitoring” includes performing clock synchronization quality monitoring independently of the given clock synchronization method used by the follower processing device(s) to discipline the clock(s) of the follower processing device(s) such that the monitoring method includes steps that are different to the steps of the given clock synchronization method.

The hardware clock of the reference processing device may be disciplined to a remote clock, such as a remote PTP clock or any remote clock over a network, or a time supplied by a Global navigation satellite system (GNSS). The follower hardware clock may be synchronized to the reference hardware clock using any suitable method, for example, by exchanging clock synchronization messages using a suitable clock synchronization method, such as Precision Time Measurement (PTM). The synchronization of the follower hardware clock to the reference hardware clock is generally performed via an interface between the two processing devices such as a data communication bus, operating according to any suitable protocol, e.g., Peripheral Component Interconnect Express (PCIe).

The reference processing device may monitor the quality of the synchronization follower hardware clock based on the follower processing device providing an indication about the follower clock value to the reference processing device, without needing to rely on clock synchronization software (which may fail) running on the follower processing device to perform the monitoring. In some embodiments, the follower processing device provides a software-independent method of receiving its clock value, such as Precision Time Measurement (PTM). In some embodiments, the follower processing device outputs periodic pulses indicative of the follower clock value to the reference processing device. For example, every second when the nanosecond value is equal to zero, (or any other suitable timing) according to the follower clock value, the follower processing device outputs a pulse to the reference processing device. In some embodiments, a hardware element in the follower processing device monitors the follower clock value and detects a wraparound of the nanosecond field of the follower clock value (i.e., when the nanosecond field passes, or is equal to, zero) and then generates a pulse output in response to detecting the wraparound. The reference processing device may then deduce from the timing of the received pulse(s) whether the follower hardware clock is sufficiently synchronized with the reference hardware clock. The periodic pulses may be sent from the follower processing device to the reference processing device from a pulse output unit (e.g., pulse per second (PPS) output) of the follower processing device to a pulse input unit (e.g., PPS input) of the reference processing device via a suitable connection (e.g., circuit board trace or clock cable).

In some embodiments, when the reference processing device receives a pulse from the follower processing device, the reference processing device retrieves the reference clock value from the reference hardware clock. In some embodiments, the reference processing device computes a clock drift between the follower clock and the reference clock based on the retrieved reference clock value. For example, if the follower processing device sends a periodic pulse at 08:00:00 according to the follower clock value and the pulse is received in the reference processing device at 08:00:00 plus 28 nanoseconds according to the reference clock value (which was retrieved by the reference processing device upon receipt of the pulse), and the delay in the connection between the follower processing device and the reference processing device is 20 nanoseconds, then the synchronization error (or clock drift) between the follower clock and the reference clock is -8 nanoseconds.

In some embodiments, the reference processing device may perform a suitable action and/or request the follower processing device to perform a suitable action based on the computed clock drift exceeding a given limit (e.g., blocking certain traffic).

In some embodiments, the reference processing device may send the computed clock drift to the follower processing device. The follower processing device may then perform a suitable action (e.g., block certain traffic or block an application from running) based on the computed clock drift exceeding a given limit.

In some embodiments, the reference processing device sends the retrieved reference clock value to the follower processing device for the follower processing device to compute the clock drift and perform a suitable action (e.g., block certain traffic or block an application from running) if necessary.

The follower processing device may send time-of-day (TOD) messages to the reference processing device intermittently, e.g., at twice the frequency or more that the periodic pulses are sent to the reference processing device so that the clock drift may be computed correctly in case the clock drift is close to or larger than half of the period of the periodic pulses. For example, if the follower clock generates a pulse at 08:00:01 (according to the follower clock) and the reference clock receives this pulse at time of 08:00:00 plus 28 nanoseconds), and the delay in the connection between the follower processing device and the reference processing device is 20 nanoseconds, without additional information, the synchronization error (or clock drift) will be calculated as -8 nanoseconds whereas in reality the time error is +999’999’992 nanoseconds (with follower clock leading the reference clock by almost a full second). Using the follower clock value included in the TOD message, the reference clock circuitry is able to disambiguate the periodic pulse (i.e., to determine which second the periodic pulse corresponds to).

In some embodiments, the follower processing device may be a host device (e.g., including a central processing unit (CPU) and/or graphics processing unit (GPU)). In some embodiments, the reference processing device may be a network device, a network switch, a network interface controller, or a timecard (e.g., including a Field Programmable Gate Array (FPGA) and GNSS receiver to receive time from a GNSS), by way of example. In some embodiments, the reference processing device and the follower processing device may be comprised in a network switch with the reference processing device including a network interface and forwarding circuitry, and the follower processing device including a processor or processors such as a CPU and/or GPU.

In some embodiments, multiple follower processing devices (e.g., multiple host devices) connected to a reference processing device (e.g., peripheral device) may be monitored by the reference processing device to monitor a quality of synchronization of each of the follower device clocks (e.g., of each of the host devices) to the reference processing device clock. In some embodiments, each of the follower processing devices may include a pulse output unit to output periodic pulses to the pulse input unit of the reference processing device in a similar manner as described above.

A pulse input-output switch (e.g., PPS switch) may be used to provide a connection between the pulse output units of each of the follower processing devices to the pulse input unit of the reference processing device. The pulse input-output switch may be installed on a motherboard of the multiple follower processing devices or on a motherboard of the reference processing device. In some embodiments, the pulse input-output switch may be a standalone device installed between the follower processing devices and the reference processing device.

In some embodiments, the periodic pulses output by the follower processing devices may be timed, e.g., in a round-robin manner, so that the reference processing device may identify which pulse is sent by which follower processing device. For example, follower processing device A outputs a pulse when its clock time is equal to 08:00:00, follower processing device B outputs a pulse when its clock time is equal to 08:00:01, follower processing device C outputs a pulse when its clock time is equal to 08:00:02, and so on.

In some embodiments, the pulse input-output switch may select which pulses received from the follower processing device are allowed to pass to the pulse input unit of the reference processing device according to some timing method, e.g., in round-robin manner. In this manner the follower processing devices do not need to time their outputs in a round-robin manner, etc.

In some embodiments, the reference processing device may include multiple pulse input units so that the pulse output unit of each follower processing device may be connected to a corresponding one of the pulse input units. In other words, each pulse input unit is connected to one of the pulse output units. In this manner, the reference processing device identifies the source of a periodic pulse based on the pulse input unit receiving the pulse and therefore a timing mechanism, e.g., round robin, does not need to be implemented among the follower processing devices.

### SYSTEM DESCRIPTION

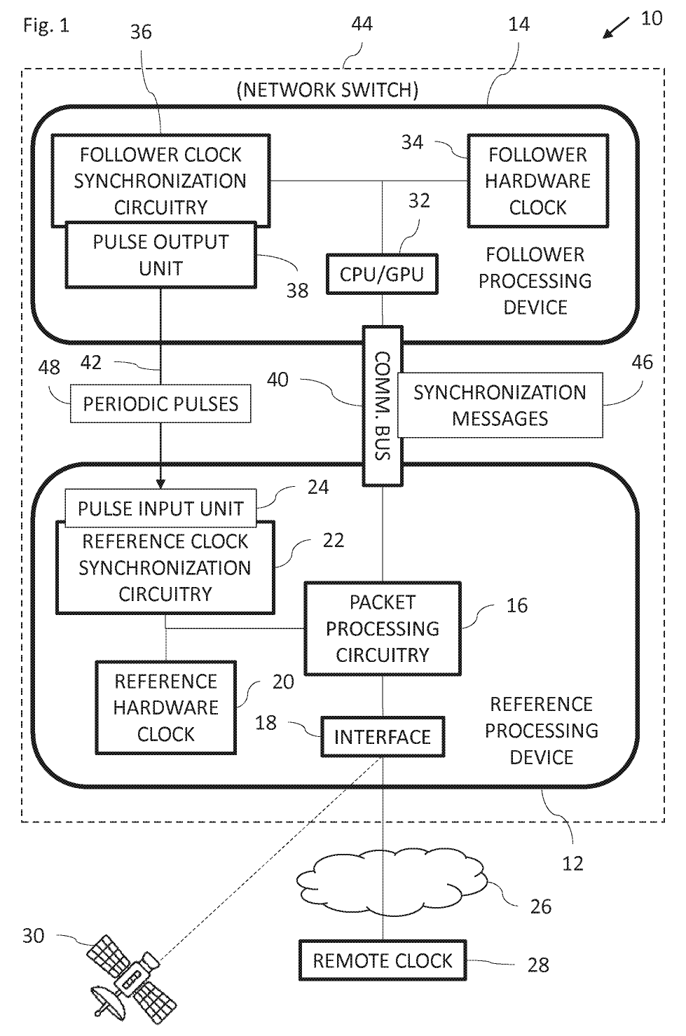

Reference is now made to FIG. 1, which is a block diagram view of a clock synchronization and monitoring system 10 constructed and operative in accordance with an embodiment of the present invention. System 10 includes a reference processing device 12 and a follower processing device 14.

Reference processing device 12 includes packet processing circuitry 16, an interface 18 (e.g., a network interface), a reference hardware clock 20, reference clock synchronization circuitry 22, and a pulse input unit 24 (e.g., a pulse per second (PPS) input unit), which may be comprised in the reference clock synchronization circuitry 22. Packet processing circuitry 16 is configured to process packets received over a network 26, and process packets for sending over the network 26. Packet processing circuitry 16 may include a physical layer (PHY) unit, and a MAC unit (not shown), among other processing components. In some embodiments, the reference processing device 12 does not include packet processing circuitry 16. Interface 18 is configured to provide a connection to network 26, for example, to exchange clock synchronization messages with a remote clock 28. In some embodiments, the interface 18 is configured to receive time data from a satellite time source 30, such as a GNSS. The reference hardware clock 20 is configured to maintain a reference clock value.

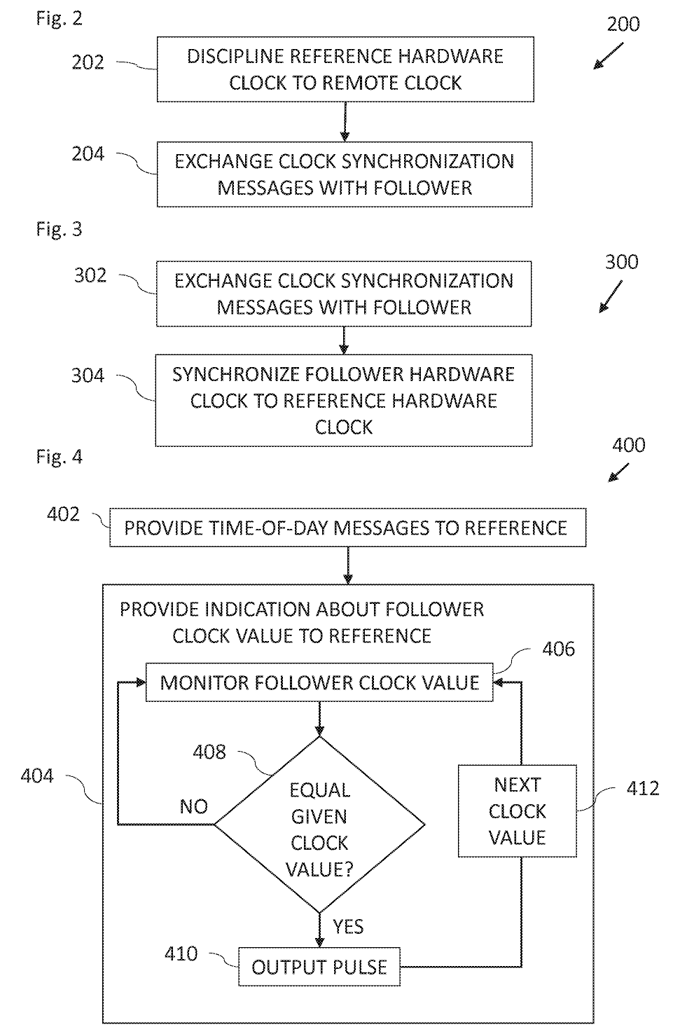

Reference clock synchronization circuitry 22 and pulse input unit 24 are described in more detail with reference to FIGS. 2 and 5. In practice, some or all of the functions of the reference clock synchronization circuitry 22 may be combined in a single physical component or, alternatively, implemented using multiple physical components. These physical components may comprise hard-wired or programmable devices, or a combination of the two. In some embodiments, at least some of the functions of the reference clock synchronization circuitry 22 may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

The follower processing device 14 includes a processor 32 (e.g., a central processing unit (CPU) or a graphics processing unit (GPU), a follower hardware clock 34, follower clock synchronization circuitry 36, and a pulse out unit 38 (e.g., a PPS output unit), which may be comprised in the follower clock synchronization circuitry 36. The follower hardware clock 34 is configured to maintain a follower clock value.

The follower clock synchronization circuitry 36 and pulse out unit 38 are described in more detail with reference to FIGS. 3, 4, and 6. In practice, some or all of the functions of the follower clock synchronization circuitry 36 may be combined in a single physical component or, alternatively, implemented using multiple physical components. These physical components may comprise hard-wired or programmable devices, or a combination of the two. In some embodiments, at least some of the functions of the follower clock synchronization circuitry 36 may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

System 10 includes a data communication bus 40 connecting the reference processing device 12 and the follower processing device 14. The data communication bus 40 may be implemented using any suitable protocol, for example, Peripheral Component Interconnect Express (PCIe). The data communication bus 40 is configured to carry data between the reference processing device 12 and the follower processing device 14, including clock synchronization messages 46. System 10 includes a connector 42 (e.g., a printed circuit board (PCB) trace or a cable) configured to connect the pulse out unit 38 to the pulse input unit 24. The connector 42 is configured to carry periodic pulses 48 from the pulse out unit 38 to the pulse input unit 24.

In some embodiments, reference processing device 12 and follower processing device 14 are comprised in a network switch 44 comprising the packet processing circuitry 16 and processor 32.

In some embodiments, reference processing device 12 may include any one or more of the following: a peripheral device, a network device to be connected to the network 26 and connect to the remote clock 28 over the network 26; a network interface controller to be connected to the network 26 and connect to the remote clock 26 over the network 26; the network switch 44 to connect to the remote clock 28 over the network 26; and/or a timecard to be connected to satellite time source 30, which is a remote clock.

Reference is now made to FIG. 2, which is a flowchart 200 including steps in a method of clock synchronization performed by reference processing device 12 of the system 10 of FIG. 1. Reference is also made to FIG. 1. The reference clock synchronization circuitry 22 is configured to discipline the reference hardware clock 20 responsively to remote clock 28, which is remote to the system 10 (block 202). In some embodiments, the reference clock synchronization circuitry 22 is configured to exchange clock synchronization messages (e.g., in accordance with a clock synchronization protocol, such as PTP) with the remote clock 28 in order to discipline the reference hardware clock 20. In some embodiments, the reference clock synchronization circuitry 22 receives a remote clock from the satellite time source 30 in order to discipline the reference hardware clock 20. In some embodiments, the reference hardware clock 20 is disciplined intermittently according to the remote clock 28 and/or the satellite time source 30.

In some embodiments, the reference clock synchronization circuitry 22 is configured to exchange clock synchronization messages 46 with the follower clock synchronization circuitry 36 over data communication bus 40 in order to synchronize the follower hardware clock 34 to the reference hardware clock 20 (block 204), for example, using a suitable clock synchronization protocol such as PTM.

In some embodiments, the reference processing device 12 does not synchronize the reference hardware clock 20 with an external device. For example, reference hardware clock 20 may be a grand master clock, or an independently running clock.

Reference is now made to FIG. 3, which is a flowchart 300 including steps in a method of clock synchronization by follower processing device 14 of the system 10 of FIG. 1. Reference is also made to FIG. 1. The follower clock synchronization circuitry 36 is configured to synchronize the follower hardware clock 34 to the reference hardware clock 20 (block 304). In some embodiments, the follower clock synchronization circuitry 36 (e.g., software running on the follower clock synchronization circuitry 36) is configured to exchange clock synchronization messages 46 with reference clock synchronization circuitry 22 (block 302) in order to synchronize the follower hardware clock 34 to the reference hardware clock 20 (block 304) using any suitable clock synchronization protocol, such as PTM. In some embodiments, the follower hardware clock 34 is synchronized intermittently to the reference hardware clock 20.

In some embodiments, the follower processing device 14 may not synchronize the follower hardware clock 34 to the reference hardware clock 20. In some embodiments, the follower processing device 14 may be configured to synchronize the follower hardware clock 34 to any suitable remote clock.

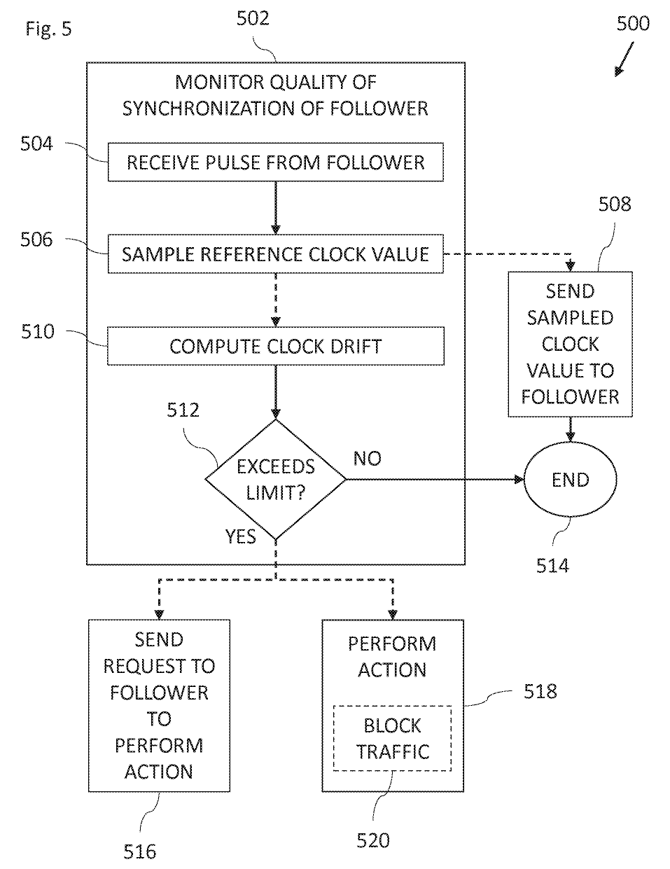

Reference is now made to FIG. 4, which is a flowchart 400 including steps in a method of providing time indications by the follower processing device 14 of the system 10 of FIG. 1. Reference is also made to FIG. 1. In some embodiments, the follower clock synchronization circuitry 36 is configured to provide time-of-day (TOD) messages intermittently (e.g., periodically) to the reference clock synchronization circuitry 22 via the data communication bus 40 (block 402). In some embodiments, the follower clock synchronization circuitry 22 is configured to provide the time-of-day messages at a frequency greater than two times the frequency of the periodic pulses 48, as described in more detail with reference to FIG. 5.

The reference processing device 12 may monitor the quality of the follower hardware clock 34 based on the follower processing device 14 providing an indication about the follower hardware clock (e.g., the follower clock value) to the reference processing device 12, without needing to rely on clock synchronization software (which may fail) running on the follower processing device 14 to perform the monitoring. Therefore, the follower clock synchronization circuitry 36 is configured to provide an indication about the follower clock value to the reference processing device 12 (block 404).

The pulse out unit 38 is configured to output periodic pulses 48 indicative of (a phase of) the follower clock value to the pulse input unit 24 via the connector 42, responsively to the follower clock value being equal to given clock values. For example, the pulse out unit 38 outputs the periodic pulses 48 every second when the nanosecond value is equal to zero, (or any other suitable timing) according to the follower clock value. In some embodiments, a hardware element, e.g., of reference clock synchronization circuitry 22, may be configured to monitor the follower clock value (block 406) and determine at a decision block 408 if the (phase of the) follower clock value is equal to a given clock value (e.g., phase). If the follower clock value is not equal to the given clock value, the step of block 406 is repeated. If the follower clock value is equal to the given clock value, the hardware element is configured to generate a pulse and the pulse out unit 38 is configured to output the generated pulse via the connector 42 to the pulse input unit 24 (block 410). The step of block 406 is then repeated based on the next clock value (e.g., the next round second) (block 412) of the follower clock value to be monitored.

For example, the hardware element may be configured to detect a wraparound of the nanosecond field of the follower clock value (i.e., when the nanosecond field passes, or is equal to, zero) and then generate a pulse output in response to detecting the wraparound. The reference processing device 12 may then deduce from the timing of the received pulse(s) whether the follower hardware clock 34 is sufficiently synchronized with the reference hardware clock 20.

In some embodiments, instead of sending periodic pulses 48 to the reference processing device 12, the follower clock synchronization circuitry 36 is configured to send any suitable indication about the follower clock value (e.g., a time-of-day message) to the reference processing device 12. In some embodiments, the reference processing device 12 may send an indication about the follower clock value when a clock parameter exceeds a given threshold. Examples of threshold values may include: a specified time duration (minimum or maximum) between events (e.g., between receiving a predetermined or configurable number of symbols); and/or a minimum or maximum number of symbols that are unmasked by a given filter in a configurable time period.

In some embodiments, the follower clock synchronization circuitry 36 is configured to send an indication about a value (or values) of one or more clock parameters of the follower hardware clock 34 to the reference processing device 12. The clock parameters may include any one or more of the following: a clock time of the follower hardware clock 34, a clock frequency of the follower hardware clock 34, a stability of the follower hardware clock 34, a filtered noise metric of the follower hardware clock 34, and/or an unfiltered noise metric of the follower hardware clock 34.

Reference is now made to FIG. 5, which is a flowchart 500 including steps in a method of monitoring a quality of the synchronization of the follower hardware clock 34 by the reference processing device 12 of the system 10 of FIG. 1. Reference is also made to FIG. 1. The reference clock synchronization circuitry 22 is configured to monitor a quality of the synchronization of the follower hardware clock 34 to the reference hardware clock 20 responsively to the provided indication (e.g., one of the periodic pulses 48) about the follower clock value from the follower processing device 14 (block 502).

The reference clock synchronization circuitry 22 is configured to receive one of the periodic pulses 48 from the pulse input unit 24 (block 504) and sample the reference clock value (from the reference hardware clock 20) responsively to receiving the periodic pulse 48 (block 506).

In some embodiments, the reference clock synchronization circuitry 22 is configured to send the sampled reference clock value to the follower processing device 14 or to a management node for analysis and taking any suitable action (block 508), for example, de-scheduling tasks from the follower processing device 14.

In some embodiments, the reference clock synchronization circuitry 22 is configured to compute a clock drift (e.g., measured in seconds) of the follower clock value from the reference clock value responsively to (i.e., based on) the sampled clock value (block 510). For example, if the follower processing device 14 sends a periodic pulse at 08:00:00 according to the follower clock value and the pulse 48 is received in the reference processing device at 08:00:00 plus 28 nanoseconds according to the reference clock value (which was sampled by the reference clock synchronization circuitry 22 upon receipt of the pulse 48), and the delay in the connection between the follower processing device and the reference processing device is 20 nanoseconds, then the synchronization error (or clock drift) between the follower clock and the reference clock is -8 nanoseconds.

In some embodiments, the reference clock synchronization circuitry 22 is configured to compute the clock drift of the follower clock value from the reference clock value responsively to (i.e., based on) the sampled clock value and at least one of the received time-of-day messages. The follower processing device 14 may send time-of-day (TOD) messages to the reference processing device 12 intermittently, e.g., at twice the frequency or more that the periodic pulses 48 are sent to the reference processing device 12 so that the clock drift may be computed correctly in case the clock drift is close to or larger than half of the period of the periodic pulses. For example, if the follower clock generates a pulse at 08:00:01 (according to the follower clock) and the reference clock receives this pulse at time of 08:00:00 plus 28 nanoseconds), and the delay in the connection between the follower processing device and the reference processing device is 20 nanoseconds, without additional information, the synchronization error (or clock drift) will be calculated as -8 nanoseconds whereas in reality the time error is +999’999’992 nanoseconds (with follower clock leading the reference clock by almost a full second). Using the follower clock value included in the TOD message, the reference clock circuitry is able to disambiguate the periodic pulse (i.e., to determine which second the periodic pulse corresponds to).The reference clock synchronization circuitry 22 is configured to determine if the clock drift of the follower clock value from the reference clock value exceeds a limit (block 512) (responsively to, i.e., based on, the sampled reference clock value, the limit, and optionally one or more of the TOD messages). If the clock drift does not exceed the limit, the method ends (block 514). If the clock drift does exceed the limit, the reference clock synchronization circuitry 22 may be configured to perform any one or more of the following: send a request to the follower processing device 14 or to the management node to perform an action (block 516); and/or perform an action (block 518), such as block a flow of packets from the follower processing device 14 (block 520). The management node may be a node connected to reference processing device 12 or follower processing device 14 via a network, or via a data communication bus for example.

In some embodiments, instead of receiving periodic pulses 48 from the follower processing device 14, the reference processing device 12 is configured to receive any suitable indication about the follower clock value (e.g., a time-of-day message) (or an indication about one or more clock parameters e.g., periodically and/or when the clock parameter(s) exceed a given threshold or thresholds, previously described) from the follower processing device 14. The indication may be sent by the follower processing device 14 intermittently (e.g., every second on the second) or upon request of the reference processing device 12. In some embodiments, upon receipt of the indication, the reference clock synchronization circuitry 22 may be configured to retrieve the reference clock value from the reference hardware clock 20 and timestamp the received indication with the time of the retrieved from the reference hardware clock 20. The reference clock synchronization circuitry 22 may be configured to: (a) send the received indication and retrieved timestamp to follower processing device 14 or the management node; or (b) compute the clock drift based on the received indication and timestamp, and (i) perform an action if the clock drift exceeds a given limit, and/or (ii) send a request to follower processing device 14 or to the management node to perform an action, such as de-scheduling tasks from the follower processing device 14.

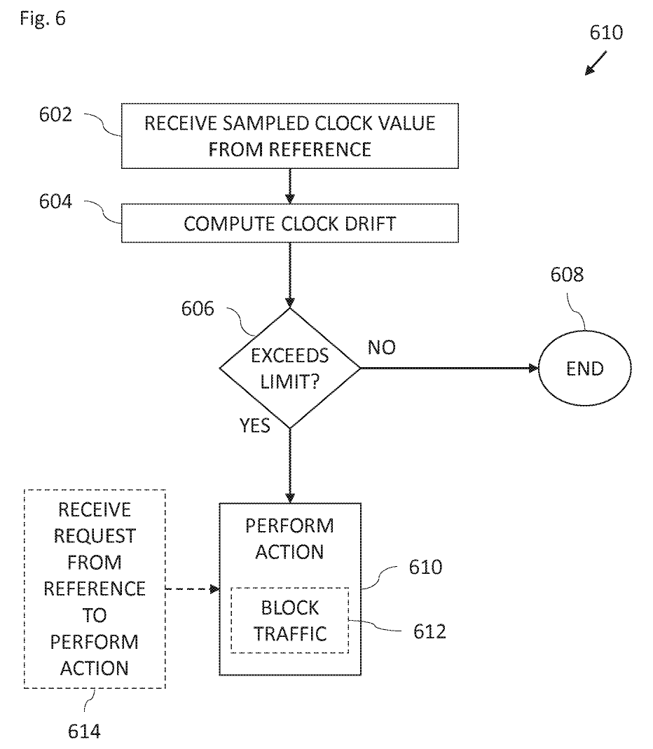

Reference is now made to FIG. 6, which is a flowchart 600 including steps in a method of acting on the method of quality monitoring of FIG. 5. Reference is also made to FIG. 1. In some embodiments, the processor 32 of the follower processing device 14 is configured to receive the sampled clock value from the reference clock synchronization circuitry 22 (block 602). The processor 32 is configured to compute the clock drift of the follower clock value from the reference clock value responsively to (i.e., based on) the sampled clock value (block 604). The processor 32 is configured to determine if the clock drift exceeds a limit (block 606) (responsively to, i.e., based on, the sampled reference clock value and the limit). If the clock drift does not exceed the limit, the method ends (block 608). If the clock drift does exceed the limit, the processor 32 may be configured to perform an action (block 610), such as block a flow traffic (block 612) or block or prevent an application from running. In some embodiments, the steps of blocks 602 and 604 may be replaced by the processor 32 or the management node receiving the computed clock drift from the reference processing device 12.

In some embodiments, the processor 32 (or the management node) is configured to: receive a request from the reference clock synchronization circuitry 22 to perform an action (block 614); and perform the requested action (block 610).

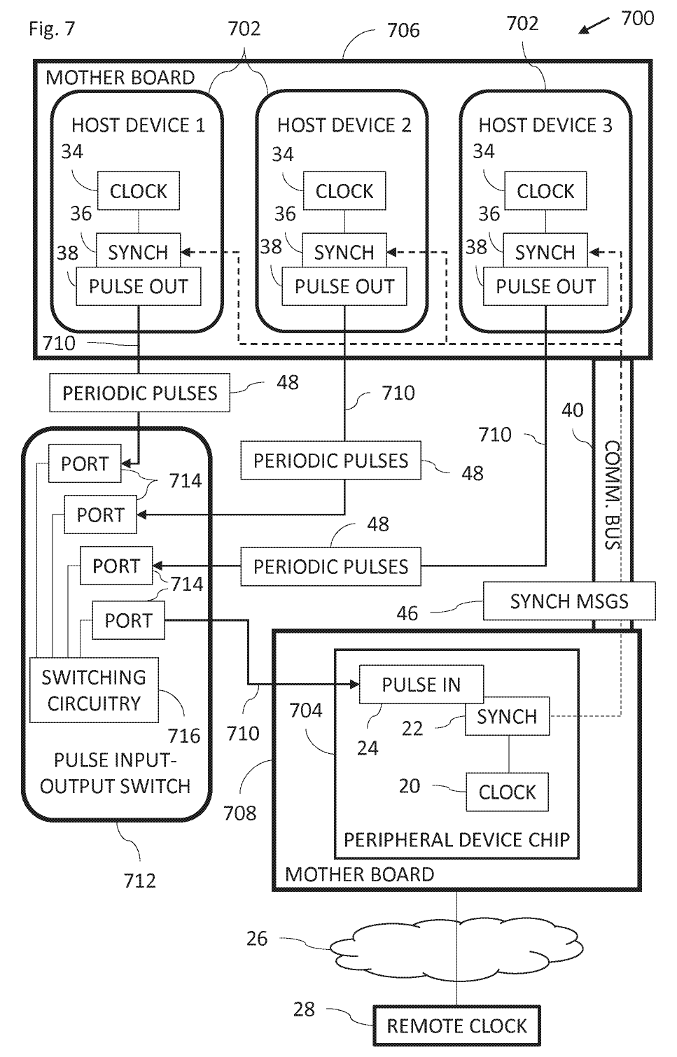

Reference is now made to FIG. 7, which is a block diagram view of a first multi-host clock synchronization and monitoring system 700 constructed and operative in accordance with an embodiment of the present invention.

System 700 includes multiple host devices 702 and a peripheral device 704, and data communication bus 40 connecting the host devices 702 to the peripheral device 704. The host devices 702 may be implemented on a motherboard 706, while the peripheral device 704 may be implemented on a motherboard 708. Each host device 702 is substantially the same as the follower processing device 14 of FIG. 1 and the peripheral device 704 is substantially the same as the reference processing device 12 of FIG. 1.

The peripheral device 704 includes reference hardware clock 20 configured to maintain a reference clock value and reference clock synchronization circuitry 22 to discipline the reference hardware clock 20 responsively to remote clock 28, which is remote to the system 700.

Each host device 702 includes follower hardware clock 34 configured to maintain a follower clock value and follower clock synchronization circuitry 36 configured to: synchronize its follower hardware clock 34 to the reference hardware clock 20 (e.g., using clock synchronization messages 46); and provide an indication (e.g., pulse 48) about the follower clock value of its follower hardware clock 34 to the peripheral device 704. The reference clock synchronization circuitry 22 is configured to monitor a quality of the synchronization of the follower hardware clock 34 of each host device 702 to the reference hardware clock 20 responsively to the provided indication (from each host device 702) about the follower clock value of the respective host device 702.

The system includes connectors 710 (e.g., circuit board traces and/or cables). The peripheral device 704 includes pulse input unit 24 (e.g., comprised in the reference clock synchronization circuitry 22). Each host device 702 includes the pulse out unit 38 (e.g., comprised in the follower clock synchronization circuitry 36). A respective one of the connectors 710 is configured to connect the pulse output unit 38 of each host device 702 to the pulse input unit 24, e.g., via a pulse input-output switch 712, which includes ports 714 and switching circuitry 716. For example, the pulse out unit 38 of host device 1 is connected to one of the ports 714 of the pulse input-output switch 712 via one of the connectors 710, the pulse out unit 38 of host device 2 is connected to another one of the ports 714 of the pulse input-output switch 712 via another one of the connectors 710, and the pulse out unit 38 of host device 3 is connected to yet another one of the ports 714 of the pulse input-output switch 712 via yet another one of the connectors 710. A further one of the ports 714 of the pulse input-output switch 712 is connected to pulse input unit 24 of the peripheral device 704 via a further one of the connectors 710. The switching circuitry 716 is connected to each of the ports 714 and may be used to configure the connections between the ports 714 so that pulses received from the pulse out units 38 of host devices 702 are forwarded or passed to pulse input unit 24 of the peripheral device 704.

The pulse out unit 38 of each host device 702 is configured to output periodic pulses indicative of the follower clock value of the respective host device 702 to the pulse input unit 24 via the respective connectors 710 and typically via the pulse input-output switch 712, responsively to the follower clock value of the respective host device 702 being equal to given clock values. The pulse input-output switch 712 is configured to receive the periodic pulses output by the pulse output unit 38 of each host device 702 and output (e.g., forward or pass) the received periodic pulses to the pulse input unit 24 of the peripheral device 704.

In order to allow the peripheral device 704 to identify which host devices 702 has sent which periodic pulse 48, in some embodiments, the pulse output unit of each host device 704 is configured to time the output of the periodic pulses 48 in a round-robin manner (for example) with respect to other ones of the host devices 704. For example, host device 1 outputs a pulse when its clock time is equal to 08:00:00, host device 2 outputs a pulse when its clock time is equal to 08:00:01, host device 3 outputs a pulse when its clock time is equal to 08:00:02, and so on.

In other embodiments, the pulse-input-output switch 712 is configured to select from the periodic pulses output by the hosts devices 702 in a round-robin manner for output to the pulse input unit 24 so that the host devices 702 do not need to time output of the pulses in a round-robin manner (for example).

In FIG. 7, the pulse-input-output switch 712 is shown as a standalone device disposed between the host devices 702 and the peripheral device 704.

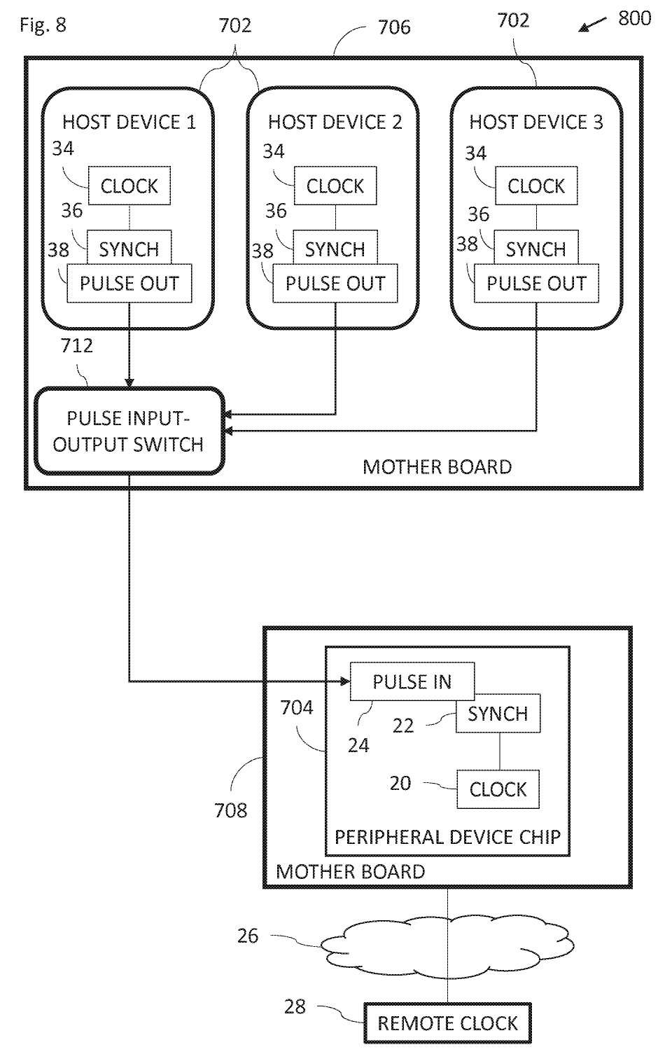

Reference is now made to FIG. 8, which is a block diagram view of a second multi-host clock synchronization and monitoring system 800 constructed and operative in accordance with an embodiment of the present invention. The system 800 is substantially the same as the system 700 of FIG. 7 except that the pulse input-output switch 712 is disposed on the motherboard 706 of the host devices 702.

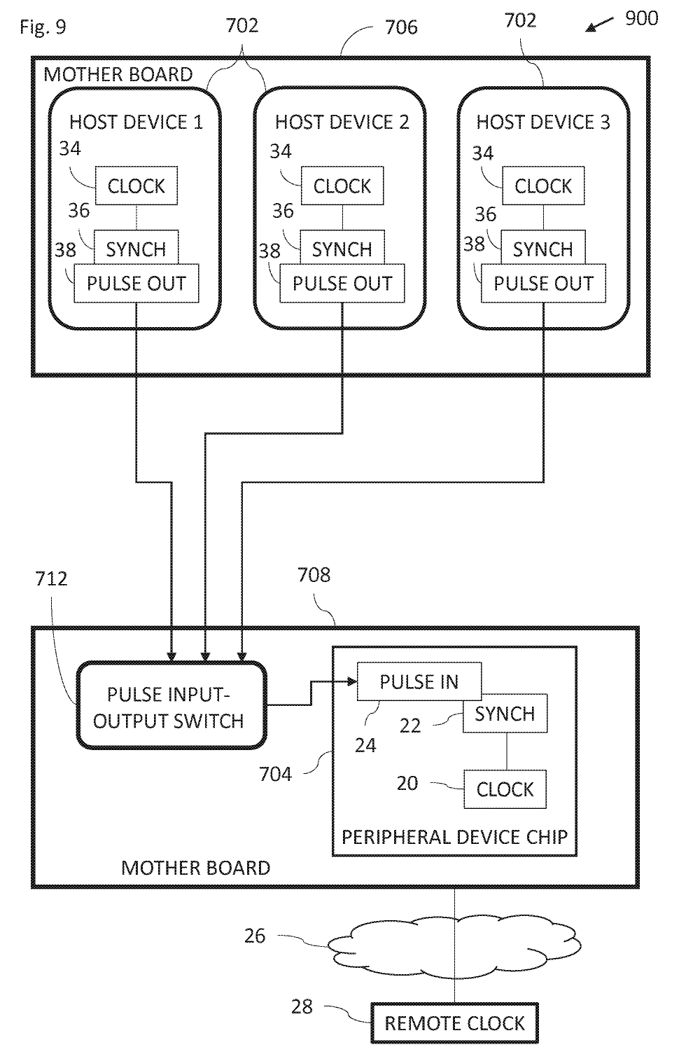

Reference is now made to FIG. 9, which is a block diagram view of a third multi-host clock synchronization and monitoring system 900 constructed and operative in accordance with an embodiment of the present invention. The system 900 is substantially the same as the system 700 of FIG. 7 except that the pulse input-output switch 712 is disposed on the motherboard 708 of the peripheral device 704.

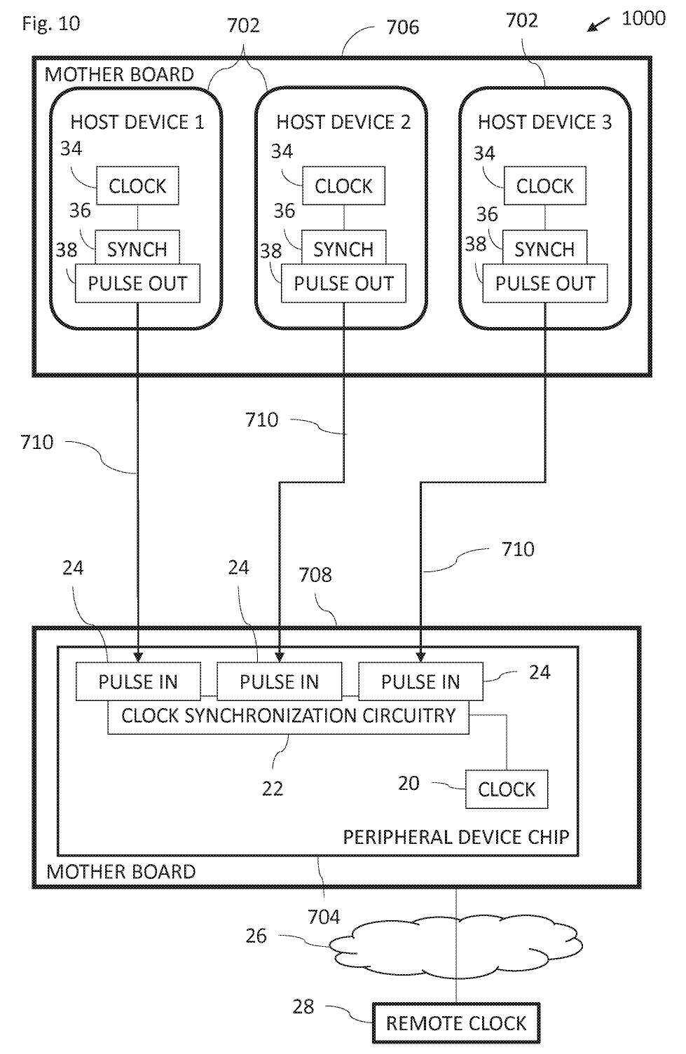

Reference is now made to FIG. 10, which is a block diagram view of a fourth multi-host clock synchronization and monitoring system 1000 constructed and operative in accordance with an embodiment of the present invention.

The system 1000 is substantially the same as the system 700 of FIG. 7 except for the following differences. The system 1000 does not need to include the pulse input-output switch 712.

The peripheral device 704 includes multiple pulse input units 24. A respective one of the connectors 710 is configured to connect the pulse output unit 38 of each host device 702 to a respective one of the pulse input units 24. For example, the pulse out unit 38 of host device 1 is connected to one of the pulse input units 24 via one of the connectors 710, the pulse out unit 38 of host device 2 is connected to another one of the pulse input units 24 via another one of the connectors 710, and the pulse out unit 38 of host device 3 is connected to yet another one of the pulse input units 24 via yet another one of the connectors 710.

The pulse out unit 38 of each host device 702 is configured to output periodic pulses indicative of the follower clock value of the respective host device 702 to the respective pulse input unit 24 via the respective connector 710, responsively to the follower clock value of the respective host device 702 being equal to given clock values. For example, the pulse out unit 38 of host device 1 is configured to output periodic pulses indicative of the clock value of host device 1 to one of the pulse input units 24 via one of the connectors 710 responsively to the clock value of host device 1 being equal to given clock values. Similarly, the pulse out unit 38 of host device 2 is configured to output periodic pulses indicative of the clock value of host device 2 to another one of the pulse input units 24 via another one of the connectors 710 responsively to the clock value of host device 2 being equal to given clock values, and so on.

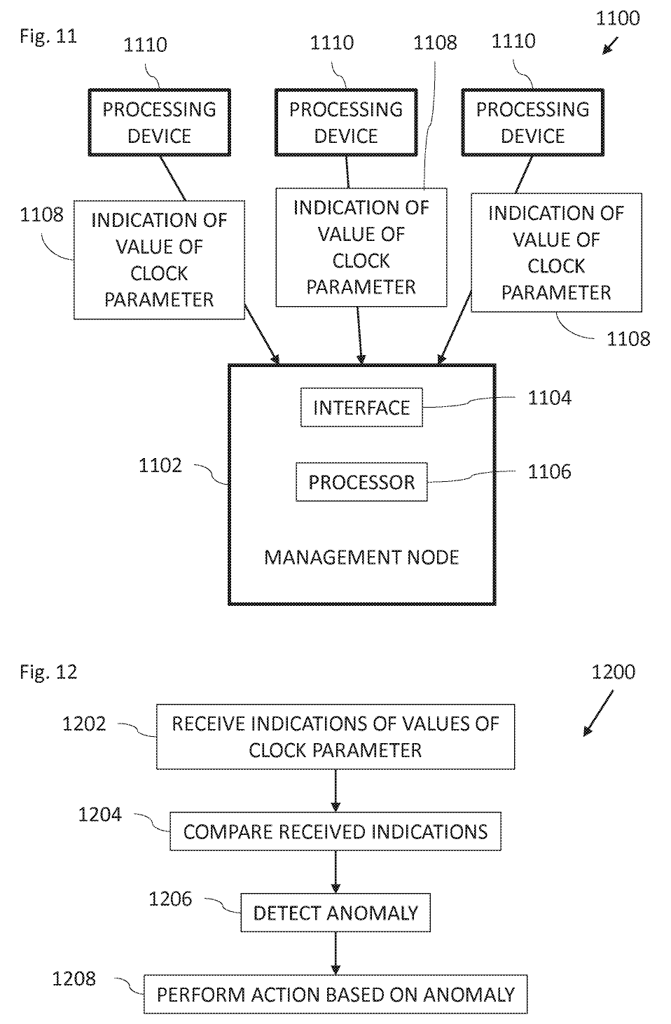

Reference is now made to FIGS. 11 and 12. FIG. 11 is a block diagram view of a clock parameter monitoring system 1100 constructed and operative in accordance with an embodiment of the present invention. FIG. 12 is a flowchart 1200 including steps in a method of operation of the system of FIG. 11.

The system 1100 includes a management node 1102, which includes an interface 1104 and a processor 1106. The interface 1104 may be a network interface and/or a data communication bus interface.

The interface 1104 is configured to receive indications 1108 of values of a clock parameter from processing devices 1110 (block 1202). The clock parameter may be selected from the following: a clock time of a hardware clock of one of the processing devices 1110 being monitored, a clock frequency of a hardware clock of one of the processing devices 1110 being monitored, a stability of a hardware clock of one of the processing devices 1110 being monitored, a filtered noise metric of a hardware clock of one of the processing devices 1110 being monitored, and/or an unfiltered noise metric of a hardware clock of one of the processing devices 1110 being monitored. The indications 1108 may be received directly from the processing devices 1110 or via one or more intermediate devices.

The processor 1106 is configured to: compare the received indications 1108 of the values of the clock parameter (block 1204); and detect an anomaly in a hardware clock of one of the processing devices 1110 responsively to comparing the received indications 1108 of the values of the clock parameter (block 1206); and perform an action based on detecting the anomaly (block 1208) such as blocking tracking of the processing device with the anomaly or de-scheduling tasks from the processing device with the anomaly. The anomaly may be detected by comparing the values of the clock parameters of the different devices and identifying a value (or values) which exceeds a given limit (e.g., percentage or standard deviation or other statistical measure) from the other received values. It should be noted that the management node 1102 may also compare the received indications 1108 with the clock parameter value(s) of the clock of the management node 1102, as in some cases the management node 1102 may have the clock with the anomaly. In some cases, more than one of the processing devices 1110 may be identified as having a clock with an anomaly.

Various features of the invention which are, for clarity, described in the contexts of separate embodiments may also be provided in combination in a single embodiment. Conversely, various features of the invention which are, for brevity, described in the context of a single embodiment may also be provided separately or in any suitable sub-combination.

The embodiments described above are cited by way of example, and the present invention is not limited by what has been particularly shown and described hereinabove. Rather the scope of the invention includes both combinations and sub-combinations of the various features described hereinabove, as well as variations and modifications thereof which would occur to persons skilled in the art upon reading the foregoing description and which are not disclosed in the prior art.

What is claimed is:

1. A clock parameter monitoring system, comprising:
an interface to receive indications of values of a clock parameter from processing devices; and
a processor to:
compare the received indications of the values of the clock parameter; and
detect an anomaly in a hardware clock of one of the processing devices responsively to comparing the received indications of the values of the clock parameter.

2. The system according to claim 1, wherein the clock parameter includes one or more of the following: a clock time of a hardware clock of one of the processing devices, a clock frequency of a hardware clock of one of the processing devices, a stability of a hardware clock of one of the processing devices, a filtered noise metric of a hardware clock of one of the processing devices, or an unfiltered noise metric of a hardware clock of one of the processing devices.

3. The system according to claim 1, wherein the processor is further to perform an action based on detecting the anomaly.

4. The system according to claim 3, wherein the action includes blocking tracking of the processing device with the anomaly or de-scheduling tasks from the processing device with the anomaly.

5. The system according to claim 1, wherein the processor is to detect the anomaly by comparing the values of the clock parameter of different ones of the processing devices and identifying a value that exceeds a limit from other received values.

6. The system according to claim 5, wherein the limit is a percentage, a standard deviation, or another statistical measure.

7. The system according to claim 1, wherein the processor is further to compare the received indications with a clock parameter value of a clock of the clock parameter monitoring system.

8. The system according to claim 1, wherein the interface includes a network interface or a data communication bus interface.

9. The system according to claim 1, wherein the indications are received directly from the processing devices.

10. The system according to claim 1, wherein the indications are received via one or more intermediate devices.

11. A clock parameter monitoring method, comprising:
receiving indications of values of a clock parameter from processing devices;
comparing the received indications of the values of the clock parameter; and
detecting an anomaly in a hardware clock of one of the processing devices responsively to comparing the received indications of the values of the clock parameter.

12. The method according to claim 11, wherein the clock parameter includes one or more of the following: a clock time of a hardware clock of one of the processing devices, a clock frequency of a hardware clock of one of the processing devices, a stability of a hardware clock of one of the processing devices, a filtered noise metric of a hardware clock of one of the processing devices, or an unfiltered noise metric of a hardware clock of one of the processing devices.

13. The method according to claim 11, further comprising performing an action based on detecting the anomaly.

14. The method according to claim 13, wherein the action includes blocking tracking of the processing device with the anomaly or de-scheduling tasks from the processing device with the anomaly.

15. The method according to claim 11, wherein detecting the anomaly comprises comparing the values of the clock parameter of different ones of the processing devices and identifying a value that exceeds a limit from other received values.

16. The method according to claim 15, wherein the limit is a percentage, a standard deviation, or another statistical measure.

17. The method according to claim 11, further comprising comparing the received indications with a clock parameter value of a clock of a monitoring system performing the method.

18. The method according to claim 11, wherein receiving the indications comprises receiving the indications via a network interface or a data communication bus interface.

19. The method according to claim 11, wherein the indications are received directly from the processing devices.

20. The method according to claim 11, wherein the indications are received via one or more intermediate devices.
